(19) United States
(12) Patent Application Publication
(10) Pub. No.: US 2012/0149265 A1
(43) Pub. Date: Jun. 14, 2012

(54) PARTICULATE COMPOSITION

(75) Inventors: Kishor Kumar Mistry, Bradford (GB); Ian Stuart Biggin, Hull (GB); Mark Christopher Baxter, Trostberg (DE); Martin Peter Butters, Bradford (GB)

(73) Assignee: BASF SE, Ludwigshafen (DE)

(21) Appl. No.: 13/381,675

(22) PCT Filed: Jun. 15, 2010
(86) PCT No.: PCT/EP2010/058368

§ 371 Date: Feb. 28, 2012

(30) Foreign Application Priority Data
Jul. 1, 2009 (GB) 0911350.7

(51) Int. Cl. B32B 5/02; C09K 5/02

(52) U.S. Cl. 442/59; 252/73; 252/77; 252/78.1

(57) ABSTRACT

A particulate composition comprising, A) an organic phase change material, B) a water insoluble polymeric matrix comprising, B1) polymeric material containing repeating monomer units formed from i) at least one hydrophobic ethylenically unsaturated monomer(s), and ii) at least one hydrophilic ethylenically unsaturated monomer(s) which provides the polymeric material with pendent functional groups, and, B2) a cross-linking component derived from a cross-linking compound which has reacted with said pendent functional groups of the polymeric material, in which the organic phase change material (A) is distributed as a separate phase throughout the water insoluble polymeric matrix (B). The invention also relates to a process of providing a particulate composition employing the steps, 1) providing an aqueous phase containing dissolved polymeric material which polymeric material contains repeating monomer units of i) at least one hydrophobic ethylenically unsaturated monomer(s), and ii) at least one hydrophilic ethylenically unsaturated monomer(s) which provides the polymeric material with pendent functional groups, 2) emulsifying the organic phase change material into the aqueous phase to form an oil in water emulsion comprising a dispersed phase of organic phase change material and a continuous aqueous phase, 3) introducing a cross-linking compound, 4) subjecting the oil in water emulsion to spray drying to evaporate water and form the particulate composition. The particulate composition can be used in a variety of thermal energy regulation or storage applications in for instance textiles, foamed articles, construction articles and electrical equipment.

The present invention relates to a particulate composition containing an organic phase change material (PCM) distributed throughout a water insoluble polymer matrix. The invention also relates to a novel method for obtaining such a particulate composition employing a spray drying step. Desirably the particulate composition is used in thermal energy regulation or storage in a variety of applications including textiles, foamed articles, construction articles and electrical equipment.

It is well known to encapsulate phase change material by various encapsulation processes described in the prior art. The processes generally involve forming microcapsules containing a core of phase change material surrounded by an outer polymeric shell. Often the microcapsule shell is an aminoplast, for instance melamine formaldehyde polymer. Other polymeric shells include acrylic polymers, for instance as described in WO 2005/105291. Various other techniques for producing microcapsules containing a core of phase change material surrounded by a polymeric shell are described in US 2008318048, U.S. Pat. No. 6,220,681, JP 2006 213914, US 2007248824, JP 2009084363. All of these publications refer to particles that contain phase change material as a single core and polymeric material only forming an outer shell.

Generally the encapsulated product is produced in the form of an aqueous dispersion of microcapsules. If a powdered (i.e. particulate) product is required it is necessary to first form the dispersion in an aqueous medium by a microencapsulation technique and then isolate the microcapsules from the aqueous medium of the dispersion by other techniques such as filtration or spray drying. Nevertheless it would be desirable to obtain powered products by more direct techniques.

Spray drying is a well-known process which has been used in the food processing industry to produce powders. For instance, liquid products, such as milk, can be sprayed through a nozzle into a stream of hot gasses to produce a powder. The increased surface area exposed in the spray mist in combination with the high temperatures of the hot gasses provides a drying effect by rapid removal of the water from the liquid product.

It is known to encapsulate other hydrophobic active ingredients intended for release by spray drying methods. However, these techniques employ encapsulating polymers which are hydrophilic, such as modified starches which release the encapsulated material upon contact with water. Other encapsulating polymers used in such spray drying techniques include gelatin or gum acacia. These polymers are also hydrophilic and would therefore dissolve upon contact with water. Therefore such techniques are unsuitable where the material is to be permanently encapsulated, as in the case of phase change materials used for thermal energy storage applications.

Spanish patent reference 2306624 relates to procedures for microencapsulation of phase change materials by spray drying. The organic phase change material is dissolved in an organic solvent containing a hydrophobic polyethylene based polymer. The organic mixture is spray dried to produce a phase change material product. The product produced will contain phase change material dissolved in the polyethylene based polymer. Furthermore, such a process will require a special closed loop solvent spray drier and such equipment is not readily available and likely to be uneconomical.

An article by Hawlader et al in Applied Energy 74 (2003) 195 to 202 mentions in outline the encapsulation of phase change material by spray drying but is silent on the encapsulating materials. We believe that it is likely that the encapsulating materials are probably gelatin or gum acacia but since these materials are hydrophilic and water-soluble they would not give a permanently encapsulated phase change material.

It would be desirable to provide particulate encapsulated phase change material products in which the phase change material is permanently entrapped. Furthermore, it would be desirable to provide this by a convenient process which is economically viable, especially using conventional apparatus.

Microencapsulated organic phase change material tends to solidify at a much lower temperature when compared to organic phase change material in non encapsulated form. This effect has been shown using differential scanning calorimetry (DSC). For instance, it has been found that microencapsulated octadecane with a volume mean diameter (VMD) of approximately 2 microns exhibits a peak melting temperature of about 28° C. and a peak solidification temperature of about 12° C. by differential scanning calorimetry (DSC) at a heating and cooling rate of 5° C./minute i.e. a temperature difference of about 16° C. This phenomenon is known as supercooling or subcooling and is more pronounced in very small capsules (microcapsules) compared to larger capsules. None of the aforementioned prior art deals with the issues concerning supercooling or subcooling.

To overcome this problem of supercooling it is known to use a nucleating agent in combination with the organic phase change material in the microcapsule in order to induce crystallization in the cooling microencapsulated organic phase change material.

U.S. Pat. No. 5,456,852 discloses a microcapsule for heat storing material containing a heat storage compound capable of undergoing phase transitions and a compound having a melting point higher than that of the heat storage compound in order to prevent supercooling of the heat storage compound. Specific examples of the high melting compound are said to be aliphatic hydrocarbon compounds, aromatic compounds, esters, such as fats and oils, fatty acids, alcohols and amides. Preference is given to fatty acids, alcohols and amides.

There are numerous prior art documents which identify nucleating agents as being particularly effective at preventing supercooling. Although certain material such as polar compounds can be used as nucleating agents and bring about improved supercooling reduction, such materials can bring about certain disadvantages due to their reactivity. In some instances they can react with other components in the microcapsule with deleterious effects.

A further objective is to provide microencapsulated organic phase change material which exhibits reduced or no supercooling which avoid the deleterious effects of nucleating agents.

According to the present invention we provide a particulate composition comprising,
A) an organic phase change material,
B) a water insoluble polymeric matrix comprising,
   B1) polymeric material containing repeating monomer units formed from
   i) at least one hydrophobic ethylenically unsaturated monomer(s), and
   ii) at least one hydrophilic ethylenically unsaturated monomer(s) which provides the polymeric material with pendent functional groups, and,
   B2) a cross-linking component derived from a cross-linking agent which has reacted with said pendent functional groups of the polymeric material, in which the organic phase change material (A) is distributed as a separate phase throughout the water insoluble polymeric matrix (B).

The present invention also concerns a process of producing a particulate composition which particulate composition comprises,
A) an organic phase change material,
B) a water insoluble polymeric matrix comprising the steps,
   1) providing an aqueous phase containing dissolved polymeric material which polymeric material contains repeating monomer units of
   i) at least one hydrophobic ethylenically unsaturated monomer(s), and
   ii) at least one hydrophilic ethylenically unsaturated monomer(s) which provides the polymeric material with pendent functional groups,
   2) emulsifying the organic phase change material into the aqueous phase to form an oil in water emulsion comprising a dispersed phase of organic phase change material and a continuous aqueous phase,
   3) introducing a cross-linking agent,
   4) subjecting the oil in water emulsion to spray drying to evaporate water and form the particulate composition,
      in which the organic phase change material (A) is distributed as a separate phase throughout the water insoluble polymeric matrix (B).

In general the steps will run sequentially 1 to 4. In which case the cross-linking agent is introduced into the oil in water emulsion. However, it may be desirable to reverse steps 2 and 3 such that the cross-linking agent is included before formation of the oil in water emulsion. In this case generally the cross-linking agent would be introduced into the aqueous phase containing the polymeric material.

It is desirable that the particulate composition of the present invention is a dry free-flowing powder.

In this process the encapsulation or entrapment of phase change material tends to occur simultaneously with the step of producing the dry particles. We believe that this direct approach offers a more efficient and economical means of obtaining the particulate phase change material product, by comparison to utilising a first encapsulation stage, for instance by aminoplast or acrylic polymers followed by a subsequent drying stage.

Although it is possible to include nucleating agents with the organic phase change material to prevent supercooling such as those nucleating agents described in U.S. Pat. No. 5,456,852, we have unexpectedly found that the composition of the present invention exhibits reduced supercooling even in the absence of any nucleating agents. We have found that the organic phase change material of the particulate composition exhibits melting and freezing point peaks, measured using differential scanning calorimetry (DSC) analysis, which are substantially the same temperature or very close temperatures in the absence of any nucleating agent. Generally the melting point peak will be below 20%, preferably below 15%, of the freezing point peak. Therefore preferably no nucleating agent will be present with the organic phase change material in the particulate composition of the present invention.

Suitably the particulate composition may comprise,
A) 1 to 90% by weight of the phase change material, and
B) 10 to 99% by weight of the polymeric matrix.

Preferably the amount of phase change material (A) will be between 50 and 80% by weight and the amount of polymeric matrix (B) being between 20 and 50% by weight based on the total weight of the particulate composition. More preferably the phase change material will be present in an amount of between 60 and 70% by weight and the amount of polymeric matrix will be between 30 and 40% by weight.

Typically the phase change material may be for instance any known hydrocarbon that melts at a temperature of between −30 and 150° C. Generally the substance is a wax or an oil and preferably has a melting point at between 20 and 80° C., often around 40° C.

Preferably the organic phase change material is selected from the group consisting of paraffin hydrocarbons, natural waxes, fatty alcohols, fatty acids, fatty esters and fatty amides. Desirably the phase change substance may be a C₈₋₄₀ alkane or may be a cycloalkane. Suitable phase change materials includes all isomers of the alkanes or cycloalkanes. In addition it may also be desirable to use mixtures of these alkanes or cycloalkanes. The phase change material may be for instance any of the compounds selected from n-octadecane, n-tetradecane, n-pentadecance, n-hexadecane, n-heptadecane, n-octadecane, n-nonadecane, n-eicosane, n-uncosane, n-docosane, n-tricosane, n-tetracosane, n-pentacosane, n-hexacosane, n-heptacosane, cyclohexane, cyclooctane, cyclodecane and also isomers and/or mixtures thereof. Examples of suitable matter waxes for use as phase change materials include beeswax, Candelilla wax, Carnauba wax, palm wax, beatle wax.

Typical fatty acids for use as phase change materials include any carboxylic acid having between 8 and 40 carbon atoms. Preferred examples of fatty acids include lauric acid, oleic acid stearic acid, other fatty acids having between 13 and 27 carbon atoms. Suitable fatty alcohols may be any alkanol that has between 8 and 40 carbon atoms, especially lauryl alcohol, stearyl alcohol and other fatty alcohols having between 13 and 27 carbon atoms. Fatty esters that can be used for this application include esters having between 8 and 40 carbon atoms, suitably methyl stearate, methyl cinnamate, methyl laurate, methyl oleate and other fatty esters having fatty acid moieties between 8 and 39 carbon atoms and lower alkyl alcohol moieties e.g. between 1 and 5 carbon atoms or alternatively fatty esters having fatty alcohol moieties between 8 and 39 carbon atoms and lower alkanoate moieties having between 1 and 5 carbon atoms. Suitable fatty amides include amides having between 8 and 40 carbon atoms and preferably stearamide, lauramide, oleamide and other amides having between 13 and 27 carbon atoms.

The water insoluble polymeric matrix of the particulate composition comprises,
B1) polymeric material containing repeating monomer units formed from
i) at least one hydrophobic ethylenically unsaturated monomer(s), and
ii) at least one hydrophilic ethylenically unsaturated monomer(s) which provides the polymeric material with pendent functional groups, and,
B2) a cross-linking component derived from a cross-linking compound which has reacted with said pendent functional groups of the polymeric material, in which the organic phase change material (A) is distributed as a separate phase throughout the water insoluble polymeric matrix (B).

The polymeric material B1 may desirably comprise,
i) 50 to 95% by weight of the at least one hydrophobic ethylenically unsaturated monomer(s), and
ii) 5 to 50% by weight of the at least one hydrophilic ethylenically unsaturated monomer(s).

Preferably the amount of the at least one hydrophobic ethylenically unsaturated monomer(s) would be between 60 and 90% by weight based on total monomer and more preferably between 70 and 90% by weight, in particular between 75 and 90% by weight and most preferably between 80 and 85%. Preferably the quantity of the at least one hydrophilic ethylenically unsaturated monomer(s) should be between 10 and 40% by weight based on total monomer and more preferably between 10 and 30 % by weight, particularly between 10 and 25% by weight and most preferably between 15 and 20% by weight.

In general the weight ratio of ethylenically unsaturated hydrophobic monomer to ethylenically unsaturated hydrophilic monomer should be 50:50 to 95:5, preferably 90:10 to 60: 40, particularly preferably 90:10 to 75:25 and especially 85:15 to 80:20.

The hydrophobic ethylenically unsaturated monomer will tend to be water insoluble. By this we mean that the solubility of the monomer in water is below 5 g monomer per 100 mls of water at 25° C. Usually the monomer solubility will be below 2 or 3 g per 100 mls of water. Desirably the hydrophobic ethylenically unsaturated monomer is selected from the group consisting of alkyl, cycloalkyl, aryl, alkaryl, aralkyl esters of mono ethylenically unsaturated carboxylic acids, acrylonitrile, methacrylonitrile, styrene, vinyl acetate, vinyl chloride and vinylidene chloride. Specific examples of suitable hydrophobic esters of mono ethylenically unsaturated carboxylic acids include esters of acrylic acid and methacrylic acid. Particularly suitable esters include C₁-C₄ alkyl (meth)acrylate, such as methyl methacrylate, methyl acrylate, ethyl (meth)acrylate, n- or isopropyl (meth) acrylate or n- , iso- or tertiary butyl (meth)acrylate; phenyl methacrylate; C₅-C₁₂ cycloalkyl(meth) acrylate, such as cyclohexyl methacrylate or isobornyl methacrylate.

One group of suitable ethylenically unsaturated hydrophobic monomers are those which are capable of forming a homopolymer having a glass transition temperature of at least 60° C., preferably at least 80° C.

Suitably the hydrophilic ethylenically unsaturated monomer will have a solubility in water of at least 5 g monomer per 100 ml water at 25° C. Usually the hydrophilic monomer will have a solubility in water of greater that this, for instance at least 7, 8 or 10 g per 100 ml. The hydrophilic monomer may be non-ionic, anionic, or cationic. Nevertheless the hydrophilic monomer should have a functional group which can be reacted with the cross-linking agent. Desirable hydrophilic ethylenically unsaturated monomers may be selected from the group consisting of mono ethylenically unsaturated carboxylic acids or salts thereof, hydroxy alkyl esters of mono ethylenically unsaturated carboxylic acids, amino alkyl esters of mono ethylenically unsaturated carboxylic acids, amino alkyl acrylamides, acrylamide, methacrylamide, and N-vinyl pyrrolidone.

Preferred hydrophilic monomers include anionic monomers which includes potentially anionic monomers such as anhydrides of carboxylic acids. Suitable anionic monomers include acrylic acid, methacrylic acid, ethyl acrylic acid, fumaric acid, maleic acid, maleic anhydride, itaconic acid, itaconic acid anhydride, crotonic acid, vinyl acetic acid, (meth)allyl sulphonic acid, vinyl sulphonic acid and 2-acrylamido-2-methyl propane sulphonic acid. Preferred anionic monomers are carboxylic acids or acid anhydrides, such as (meth)acrylic acid.

The particular monomers used and their relative amounts to form the polymeric material B1 should be such that the polymeric material is water soluble, at least when neutralised with ammonium or a suitable volatile amine compound. By water-soluble we mean that the polymer has a solubility in water of at least 5 g per 100 ml at 25° C. The monomers should be chosen such that when reacted with the cross-linking agent the thus formed polymeric matrix is water insoluble i.e. with a solubility of below 5 g per 100 ml.

A particularly preferred polymeric material B1 is a copolymer of methyl methacrylate with ammonium acrylate.

The polymeric material B1 may be prepared by any suitable polymerization process. For instance, the polymer can be prepared by aqueous emulsion polymerization, such as the one described in EP-A-697423 or U.S. Pat. No. 5,070,136. Typically the hydrophilic monomer may be an anionic monomer as the free acid and emulsified into water to form an aqueous emulsion which is polymerised. The resulting polymer can then be neutralized by the addition of a suitable base to neutralise the anionic groups so that the polymer dissolves in the aqueous medium to form an aqueous solution. Alternatively the anionic monomer may be neutralised first and then copolymerised with the hydrophobic monomer.

When the hydrophilic monomer used to form the polymeric material is anionic it is preferred that the base provides a neutralising counterion which can be readily removed under conditions of elevated temperature. This may be referred to as a volatile counterionic component. More preferably the base is ammonia, ammonium hydroxide or a volatile amine component. The volatile amine component is a liquid that can be evaporated at low to moderate temperatures, for instance by temperatures up to 200° C. Preferably, it will be possible to evaporate the volatile amine under reduced pressure at temperatures below 100 ° C. The polymer may be produced in free acid form and then neutralized with an aqueous solution of ammonium hydroxide or a volatile amine, for instance ethanolamine, methanolamine, 1-propanolamine, 2-propanolamine, dimethanolamine or diethanolamine. Alternatively the polymer may be prepared by copolymerizing the ammonium or volatile amine salt of an anionic monomer with the hydrophobic monomer.

In a typical polymerization process, the blend of hydrophobic monomer and anionic monomer is emulsified into an aqueous phase which contains a suitable amount of emulsifying agent. The emulsifying agent may be any commercially available emulsifying agent suitable for forming aqueous emulsion. These emulsifying agents will tend to be more soluble in the aqueous phase than in the water immiscible monomer phase and thus will tend to exhibit a high hydrophilic lipophilic balance (HLB). Emulsification of the monomer may be effected by known emulsification techniques, including subjecting the monomer/aqueous phase to vigorous stirring or shearing or alternatively passing the monomer/aqueous phase through a screen or mesh. Polymerization may then be effected by use of a suitable initiator system, for instance a UV initiator or thermal initiator. A suitable technique of initiating the polymerization would be to elevate the temperature of an aqueous emulsion of monomer to above 70 or 80° C. and then add between 50 and 1000 ppm of ammonium persulphate by weight of monomer.

It is possible that the ethylenically unsaturated hydrophilic monomer is cationic which includes potentially cationic, for instance an ethylenically unsaturated amine.

In this form of the invention when a volatile counterionic component is employed this may be a volatile acid component. The polymeric material B1 can be formed in an analogous way to the aforementioned anionic polymeric material, except that the anionic monomer is replaced by a cationic or potentially cationic monomer. In the event that the polymer is prepared in the form of a copolymer of a free amine and hydrophobic monomer, it is neutralized by including a suitable volatile acid, for instance acetic acid or formic acid. Preferably the polymer is neutralized by a volatile carboxylic acid.

Suitable cationic monomers include dialkyl aminoalkyl (meth) acrylates, dialkyl aminoalkyl (meth) acrylamides or allyl amines and other ethylenically unsaturated amines and their acid addition salts. Suitable dialkyl aminoalkyl (meth)acrylates include dimethyl aminomethyl acrylate, dimethyl aminomethyl methacrylate, 2-dimethylaminoethyl acrylate, dimethyl aminoethyl methacrylate, diethyl aminoethyl acrylate, diethyl aminoethyl methacrylate, dimethyl aminopropyl acrylate, dimethyl aminopropyl methacrylate, diethyl aminopropyl acrylate, diethyl aminopropyl methacrylate, dimethyl aminobutyl acrylate, dimethyl aminobutyl methacrylate, diethyl aminobutyl acrylate and diethyl aminobutyl methacrylate. Typical dialkyl aminoalkyl (meth) acrylamides include dimethyl aminomethyl acrylamide, dimethyl aminomethyl methacrylamide, dimethyl aminoethyl acrylamide, dimethyl aminoethyl methacrylamide, diethyl aminoethyl acrylamide, diethyl aminoethyl methacrylamide, dimethyl aminopropyl acrylamide, dimethyl aminopropyl methacrylamide, diethyl aminopropyl acrylamide, diethyl aminopropyl methacrylamide, dimethyl aminobutyl acrylamide, dimethyl aminobutyl methacrylate, diethyl aminobutyl acrylate and diethyl aminobutyl methacrylamide. Typical allyl amines include diallyl amine and triallyl amine.

The polymeric material B1 desirably has a weight average molecular weight of up to 200,000 (determined by GPC using standard industrial parameters). Preferably the polymer has a weight average molecular weight of below 50,000, for instance 2,000 to 30,000. According to a preferred embodiment, the optimum molecular weight for the matrix polymer is around 6,000 to 25,000.

The cross-linking agent should be capable of reacting with the functional group of the ethylenically unsaturated monomer units of the polymeric material. For instance, when the polymer chain contains anionic groups, suitable cross-linking agents include aziridines, diepoxides, carbodiamides, silanes or multivalent metals, for instance aluminum, zinc or zirconium. More preferably the cross-linking agent is a multivalent metal compound, for instance oxides, hydroxides, carbonates or salts of aluminium, zinc or zirconium. A particularly preferred cross-linking agent is ammonium zirconium carbonate or zinc oxide. Another particularly preferred class of cross-linking agents includes compounds that form covalent bonds between polymer chains, for instance silanes or diepoxides.

The cross-linking process desirably occurs during the dehydration step during the spray drying stage. Preferably the cross-linking compound will react with sufficient of the functional groups of the hydrophilic monomer units so as to render the polymeric material water insoluble. Desirably the cross-linking agent should not react with the functional groups to any significant amount prior to the spray drying stage.

Desirably in step 3) of the process of the present invention sufficient of the cross-linking compound is added to react with substantially at least 60% of the functional groups of the polymeric material. Preferably the quantity of cross-linking agent should be sufficient to react with at least 80% and more preferably 90% of the functional groups of the polymeric material. More preferably still the cross-linking agent should react with at least 95% of the functional groups, especially at least 98 or 99% and in some cases even 100%.

Preferably the functional groups of the hydrophilic monomer are carboxylic acid units, including salts thereof, and the cross-linking agent is a substance which reacts with carboxylic acids under elevated temperatures, for instance the temperatures occurring in a spray drying unit. Suitably the cross-linking agent may be a multi-hydroxy compound which would react to form an ester linkage. Typically the multi-hydroxy compound may be a hydroxy functional polymer, for instance polyvinyl alcohol.

The amount of cross-linking agent may be up to 90% by weight of the polymeric material B1. In general the amounts of cross-linking agent required will increase as the concentration of hydrophilic monomer units in the polymeric material B1 increases. Desirably the amount of cross-linking agent may be up to 70% by weight of the polymeric material. Preferably the amount of cross-linking agent will be less than 50% and usually between 1 and 30% by weight of the polymeric material. Satisfactory results may be obtained when using a multivalent metal compound as the cross-linking agent, suitably between 5 and 20%, more preferably between 10 and 20%. More desirable results may sometimes be obtained when using a combination of multivalent metal compound in addition to a hydroxy functional polymeric material. In this case the amount of multivalent metal compound may be as defined above specifically between 5 and 20%, more preferably between 10 and 20%. The amount of hydroxy functional polymeric material may be equivalent to the multivalent metal compound as defined above all typically between 5 and 20%, more preferably between 10 and 20%.

The choice and ratios of monomers to form the polymeric material B1 and the choice and the amounts of cross-linking agent(s) may also be made in order to provide the polymer matrix with a relatively high glass transition temperature (Tg). Desirably the matrix polymer should not have a Tg which is too low since it may become sticky and adhere to the walls of the spray drier chambers. Since it is desirable that the particulate composition of the present invention is formed as a dry free-flowing powder it is preferred that the Tg is relatively high to avoid the formation of sticky particles which may stick to the interior of the spray drier chamber and/or stick to each other to form agglomerates. Preferably the glass transition temperature of the polymeric matrix of the particulate composition is in excess of 50° C., more preferably in excess of 60° C., in particular greater than 80° C., especially greater than 100° C. and most preferably greater than 110° C. There is generally no maximum glass transition temperature provided that the other properties of the polymeric material B1 and cross-linking agent B2 and of the polymeric matrix are not compromised. The glass transition temperature may be as much as 200° C. or 250° C. or greater.

The glass transition temperature (Tg) for a polymer is defined in the Kirk-Othmer, Encyclopedia of Chemical Technology, Volume 19, fourth edition, page 891, as the temperature below which (1) the transitional motion of entire molecules and (2) the coiling and uncoiling of 40 to 50 carbon atom segments of chains are both frozen. Thus, below its Tg a polymer would not exhibit flow or rubber elasticity. The Tg of a polymer may be determined using Differential Scanning calorimetry (DSC).

The process of obtaining the particulate composition conveniently employs an aqueous solution of polymeric material B1. Preferably the solution polymeric material will exist as a salt which will decompose during the spray drying step such that the neutralising counterion is removed to reveal the free acid which will readily react with the cross-linking agent.

Therefore it is preferred that the polymeric material in step 1) is an ammonium or volatile amine salt of a polymer comprising repeating units of a mono ethylenically unsaturated carboxylic acid and a mono ethylenically unsaturated hydrophobic monomer.

Thus in the case of the preferred salts of the polymeric material including ammonium or salts of volatile amines during the spray drying step ammonia in the case of ammonium salts or the volatile amines will be released thereby providing a free acid groups which are free to react with the cross-linking agent.

During the spray drying stage droplets of the water in the emulsion desirably should be dehydrated to form particles containing the polymeric matrix B throughout which the phase change material is distributed as a separate phase. Since the polymeric matrix desirably should have been rendered water insoluble during the spray drying step the phase change material should be permanently encapsulated by the polymeric matrix.

The formation of the aqueous emulsion in step 2) of the process may be achieved by any conventional emulsification techniques, for instance using conventional homogenising equipment. On a small scale this may be achieved using a Silverson homogeniser or a Moulinex blender. On a larger scale it may be more desirable to use larger size industrial equipment, for instance Ultra Turrax. Alternatively it would be possible to form the aqueous emulsion by passing the mixture of aqueous phase and phase change material through a screen. Since the polymeric material contains both hydrophilic and hydrophobic moieties it will act as an emulsifying surfactant for forming and stabilising the emulsion. Desirably the dispersed phase of the emulsion containing the phase change material should have a volume average particle size of less than 5 μm, preferably less than 2 μm. This can be determined by differential light scattering techniques such as Sympatec HELOS particle size analyzer or Malvern Mastersizer Model 1002.

The spray drying equipment used in the process of the present invention may be any conventional spray drying unit suitable for spray drying aqueous liquids. Generally spray drying equipment will be used in a conventional manner, for instance using conventional temperatures, conventional flow rates and conventional residence times. Preferably in step 4 of the present invention the oily water emulsion is passed through a spray drying unit with a temperature of at least 120° C., more preferably at least 150° C., and still more preferably at least 180° C. Generally the temperature will should be between 180° C. to 220° C. and will usually be not below 120° C.

Preferably in step 4) of the process of present invention the oil in water emulsion is passed through a spray drying unit in which the flow rate of the oil in water emulsion and the spray outlet of the spray drying unit are adapted to provide a particulate composition with the desired particle size. Generally the volume average particle size diameter of the particles is less than about 100 μm (microns, micrometer). Preferably the volume average particle size diameter is in the range of about 1 to 60 μm, e.g. 1 to 40 μm, especially between 1 and 30 μm and in particular between 10 and 30 μm. The volume average particle size is determined by a Sympatec HELOS particle size analyzer according to standard procedures well documented in the literature.

The particulate composition of the present invention may be used in a variety of thermal energy storage applications for providing temperature regulation or storage. Desirably the particulate composition may be used in a variety of articles, for instance in coatings for textiles, textile articles, foam articles, construction articles and electrical equipment. Examples of construction articles include the variety of building materials used in the building industry including wall panels and ceiling panels etc. In the case of electrical equipment the particulate composition should provide thermal energy regulation in order to prevent overheating.

The following examples are an illustration of the invention without intending to be in any way limiting.

### EXAMPLE 1

This example illustrates the preparation of polymer particles containing 67% paraffin wax and 33% encapsulating polymer.

An aqueous feed is prepared by diluting 88.8 g of 16.9% methyl methacrylate—acrylic acid copolymer ammonium salt (82.5/17.5 weight % monomer ratio, molecular weight 20,000) with 41.4 g of deionised water. This diluted mixture is placed under an overhead homogeniser (Silverson L4R) and then 30 g of Kenwax 19 (ex-Witco paraffin wax with melting point of 30° C.) added under high shear mixing. The resulting oil-in-water emulsion was homogenised for total time of 15 minutes to form a uniform smooth wax emulsion. Next 1.9 g of zinc oxide (ex-Norkem Chemicals) is added to the wax emulsion under the homogeniser mixer.

The aqueous wax emulsion is then spray dried at an inlet temperature of 180° C. at a feed rate of 3ml/min using a laboratory spray dryer (Buchi Model B191). The final product is a free flowing white powder containing entrapped paraffin wax which has a mean particle size of 18.9 microns. The encapsulated paraffin wax had a melting point peak of 33.2° C. and freezing point peak of 29.2° C. and enthalpy of 62 J/g as determined by Differential Scanning calorimetry (DSC).

### EXAMPLE 2

This example illustrates the preparation of polymer particles containing 61% paraffin wax and 39% encapsulating polymer with use of polyvinyl alcohol as the additional hydroxyl functional polymeric crosslinking material.

An aqueous feed is prepared by diluting 88.8g of 16.9% methyl methacrylate—acrylic acid copolymer ammonium salt (82.5/17.5 weight % monomer ratio, molecular weight 20,000) with 41.4 g of deionised water and then adding 40 g of 5.3% polyvinyl alcohol solution (Gohsenol GL05). To this aqueous phase was added 30 g of Kenwax 19 under the high shear mixer to form the wax emulsion followed by dispersing 1.9 g zinc oxide. The resulting aqueous mixture was spray dried according the procedure described in Example 1 to give a white powdered product having a mean particle size of 10.6 microns. The encapsulated paraffin wax had a melting point peak of 32.9° C. and freezing point peak of 28.9° C. and enthalpy of 55 J/g as determined by Differential Scanning calorimetry (DSC).

### EXAMPLE 3

The encapsulated PCM samples of Examples 1 to 2 were subjected to two characterisation tests:
1. Stability in Water: 1 g sample dispersed in 50g water and after 5 hours the test sample examined under a light microscope for any physical disintegration or dissolution of the encapsulated particles.
2. Thermo-gravimetric analysis (TGA) using a Perkin Elmer TGA with a temperature range of 110° C. to 500° C.

Both the polymer particles of Examples 1 and 2 remain discrete and intact in contact with water showing that particles remain inert for use in their intended end applications i.e. the products can be formulated in aqueous formulation for use in construction and textile applications.

The results of thermogravimetric analysis are summarised in Table 1.

TABLE 1

| | | | ²Mass loss @ |
|---|---|---|---|
| Sample from | Stability in Water | ¹Half-Height (° C.) | 300° C. (%) |
| Example 1 | Remain discrete & | 352 | 30.8 |
| | fully intact particles | | |
| Example 2 | Remain discrete & | 322 | 34.9 |
| | fully intact particles | | |
| Unencapsulated | Not applicable | 247 | 100 |
| Kenwax 19 | | | |
| paraffin wax | | | |

¹Half height: this is the half-height of the decay curve.
²Mass loss @ 300° C.: this is the amount of material lost (expressed as a percentage) from the sample between the starting condition, 110° C., and 300° C.

The quality of encapsulation can been seen by comparison of the half-height values—the higher the half-height , the more resistant the microcapsules to rupture due to build up of internal pressure i.e. the more robust the wall. Unencapsulated paraffin wax (Kenwax 19) loses 50% of its mass on heating at 247° C. but on encapsulation with matrix polymer of invention this can be substantially increased to >320° C. whilst simultaneously reducing the mass loss to around 30%. This is indicative of effective retention of the entrapped wax within the polymer particles of the present invention.

1. A particulate composition, comprising:
(A) an organic phase-change material; and
(B) a water-insoluble polymeric matrix,
wherein
the water-insoluble polymeric matrix (B) comprises:
(B1) a polymeric material containing comprising a repeating monomer unit formed from
(i) at least one hydrophobic ethylenically-unsaturated monomer, and
(ii) at least one hydrophilic ethylenically-unsaturated monomer providing the polymeric material with at least one pendent functional group; and
(B2) a cross-linking component obtained from a cross-linking compound which has reacted with the at least one pendent functional group of the polymeric material (B1), and
the organic phase-change material (A) is distributed as a separate phase throughout the water-insoluble polymeric matrix (B).

2. A particulate The composition of claim 1, comprising
(A) 1 to 90% by weight of the phase-change material, and
(B) 10 to 99% by weight of the polymeric matrix.

3. The composition of claim 1, wherein the polymeric material (B1) comprises
(i) 50 to 95% by weight of the at least one hydrophobic ethylenically-unsaturated monomer, and
(ii) 5 to 50% by weight of the at least one hydrophilic ethylenically-unsaturated monomer.

4. The composition of claim 1, in which wherein the hydrophobic ethylenically-unsaturated monomer (i) is at least one selected from the group consisting of an ester of a mono-ethylenically-unsaturated carboxylic acid, acrylonitrile, methacrylonitrile, styrene, vinyl acetate, vinyl chloride and vinylidene chloride.

5. The composition of claim 1, wherein the hydrophilic ethylenically-monomer (ii) is at least one selected from the group consisting of a mono-ethylenically-unsaturated carboxylic acid, a salt of a mono-ethylenically-unsaturated carboxylic acid, a hydroxy alkyl ester of a mono-ethylenically-unsaturated carboxylic acid, an amino alkyl ester of a mono-ethylenically-unsaturated carboxylic acid, an amino alkyl acrylamide, an acrylamide, a methacrylamide, and N-vinyl pyrrolidone.

6. The composition of claim 1, wherein the cross-linking component (B2) is obtained from a cross-linking compound consisting of a multivalent metal compound.

7. A process of producing a particulate composition comprising (A) an organic phase-change material and (B) a water-insoluble polymeric matrix, the process comprising
(1) emulsifying the organic phase-change material into an aqueous phase to form an oil-in-water emulsion comprising a dispersed phase of the organic phase-change material and a continuous aqueous phase,
(2) adding a cross-linking compound to the oil-in-water emulsion, and
(3) spray drying the oil-in-water emulsion to evaporate water and to form the particulate composition,
wherein:
the aqueous phase comprises a dissolved polymeric material comprising a repeating monomeric unit formed from
(i) at least one hydrophobic ethylenically-unsaturated monomer, and
(ii) at least one hydrophilic ethylenically-unsatured monomer providing the polymeric material with at least one pendent functional group; and
the organic phase-change material (A) is distributed as a separate phase throughout the water-insoluble polymeric matrix (B).

8. The process of claim 7, wherein the dissolved polymeric material is an ammonium or volatile amine salt of a polymer comprising repeating units of a mono-ethylenically-unsaturated carboxylic acid and a mono-ethylenically-unsaturated hydrophobic monomer.

9. The process of claim 7, wherein the dispersed phase of the phase-change material has a volume average particle size of less than 5 μm.

10. The process of claim 7, wherein a sufficient amount of the cross-linking compound is added (2) to react with at least 90% of the at least one pendent functional group of the dissolved polymeric material.

11. The process of claim 7, wherein, during the spray drying (3), the oil-in-water emulsion is passed through a spray drying unit with an inlet temperature of at least 100° C.

12. The process of claim 7, wherein, during the spray drying (3), the oil-in-water emulsion is passed through a spray drying unit in which the flow rate of the oil-in-water emulsion and the spray outlet of the spray drying unit provide the particulate composition with a volume average particle size of greater than 5 μm.

13. An article providing thermal regulation and storage, comprising the particulate composition of claim 1.

14. The article of claim 13, wherein the article is at least one selected from the group consisting of a coating for textiles, a textile article, a foamed article, a construction article, and an electrical article.

15. The process of claim 7, wherein the dispersed phase of the phase-change material has a volume average particle size of less than 2 μm.

16. The process of claim 7, wherein, during the spray drying (3), the oil-in-water emulsion is passed through a spray drying unit in which the flow rate of the oil-in-water emulsion and the spray outlet of the spray drying provide the particular composition with a volume average particle size of between 10 μm and 100 μm.

17. The composition of claim 1, wherein the hydrophobic ethylenically-unsaturated monomer (i) is at least one selected from the group consisting of an alkyl ester, a cycloalkyl ester, an aryl ester, an alkaryl ester, and an aralkyl ester, of a mono-ethylenically-unsaturated carboxylic acid.
